(19) United States
(12) Patent Application Publication
(10) Pub. No.: US 2021/0278258 A1
(43) Pub. Date: Sep. 9, 2021

(54) Pressure or temperature transmitter device without electronic transducer

(71) Applicant: Jayme Francis Paille, Youngsville, LA (US)

(72) Inventor: Jayme Francis Paille, Youngsville, LA (US)

(21) Appl. No.: 16/807,626

(22) Filed: Mar. 3, 2020

(51) Int. Cl. G01D 7/00; G01D 13/22; H04Q 9/02; H04W 12/00

(52) U.S. Cl. CPC G01D 7/00; G01D 13/22; H04Q 9/02; H04Q 2209/883; H04Q 2209/40; H04Q 2209/823; H04W 12/001

(57) ABSTRACT

A unique, wireless pressure or temperature transmitter apparatus that substitutes unnecessary transmission information with simplicity and efficiency. The battery powered device utilizes a pressure or temperature gauge with adjustable switch contacts to wirelessly transmit the electrical state of the switch contacts rather than a pressure or temperature value. This is used in an application where the measured value is not needed to be known, but rather, if the measured value has or has not reached a specific value.

### SUMMARY

The present invention uses a non-electric assembly for pressure or temperature measurement. When operational, measurement assembly mechanically turns a shaft coupled to an indication needle. The indication needle points to a calibrated pressure or temperature value displayed on a gauge face mounted behind the indication needle. This value being pointed at is the current pressure or temperature value measured via inlet or attached temperature probe. The present invention caters to applications that don't require transmission of a pressure and/or temperature value(s). Located on either side of the indication needle are adjustable switch contacts. When the indication needle makes physical contact with these adjustable switch contact(s), a circuit is completed between the indication needle and the switch contact it is touching. Instead of transmitting a pressure or temperature value and therefore needing a programmed auxiliary controller device to interpret pressure and/or temperature value(s) and execute according actions, the present invention only transmits an indication if pressure or temperature threshold limit(s) have been met or have not been met. These threshold limit(s) are mechanically adjustable switch contact(s) and do not require tools and/or software to modify. This is a robust, power saving feature, relative to a screen and/or an electronic transducer. Only transmitting an indication if a limit has been or has not been reached requires much less complex programming of an auxiliary control device, saving expensive programming fees and potentially significant down time. Although assemblies with adjustable switch contact(s) (as described in the embodiment of this invention) have been designed for short, wired connections and are typically mounted in very close proximity, or even on a control panel for the device they control, having a wireless device would open up new use opportunities.

### BRIEF DESCRIPTION OF DRAWINGS

FIG. 1. is a top view of an embodiment the present invention with housing cover and adjustable switch contacts removed.

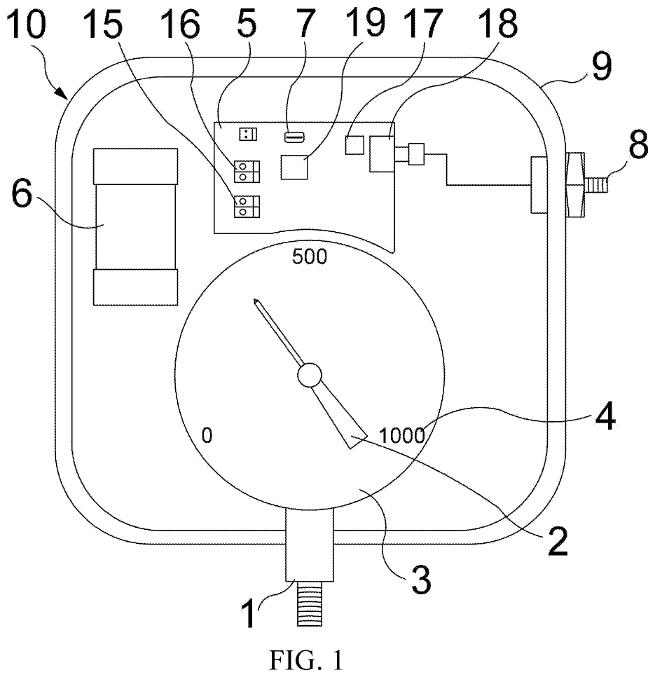

FIG. 2. is a top view of an embodiment of the present invention with cover.

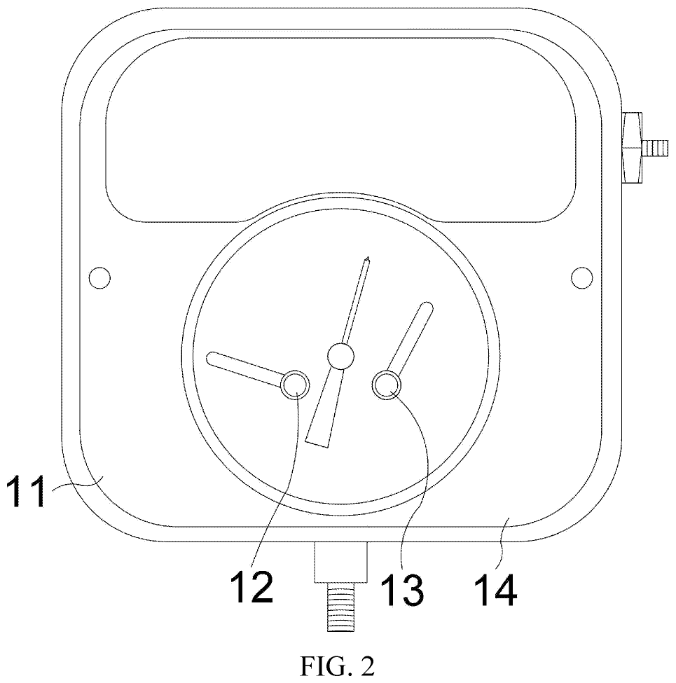

FIG. 3. is a diagrammatic view of the devices in accordance with an embodiment of the present invention.

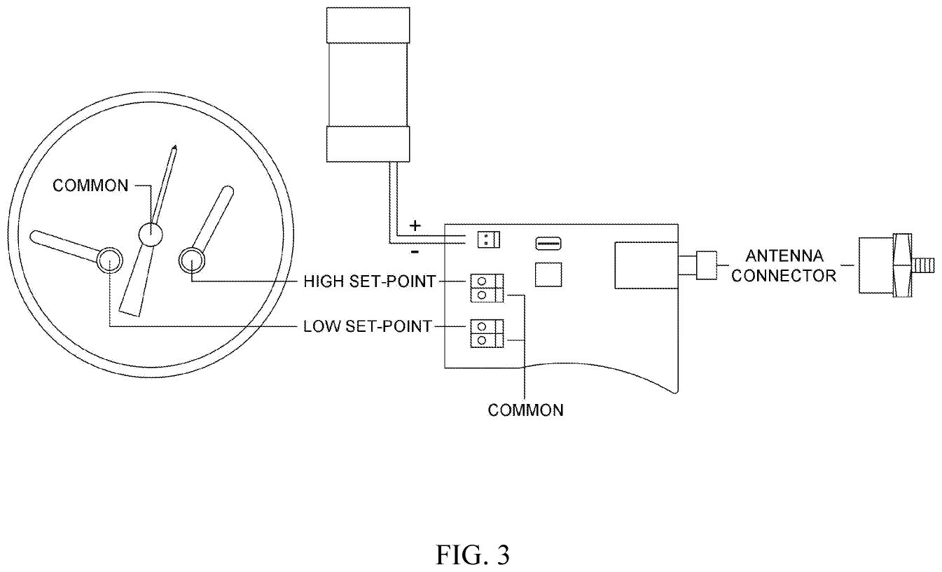

FIG. 4. is a top view of a pressure measuring assembly within embodiment of the present invention.

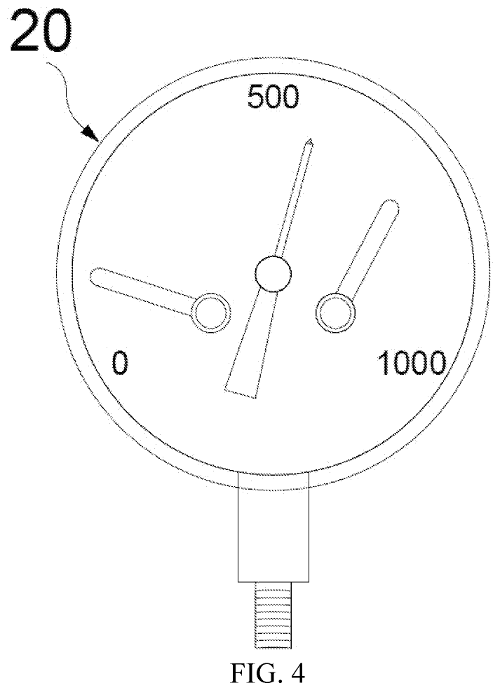

FIG. 5. is a top view of another embodiment of the present invention with electronics housed in separate housing.

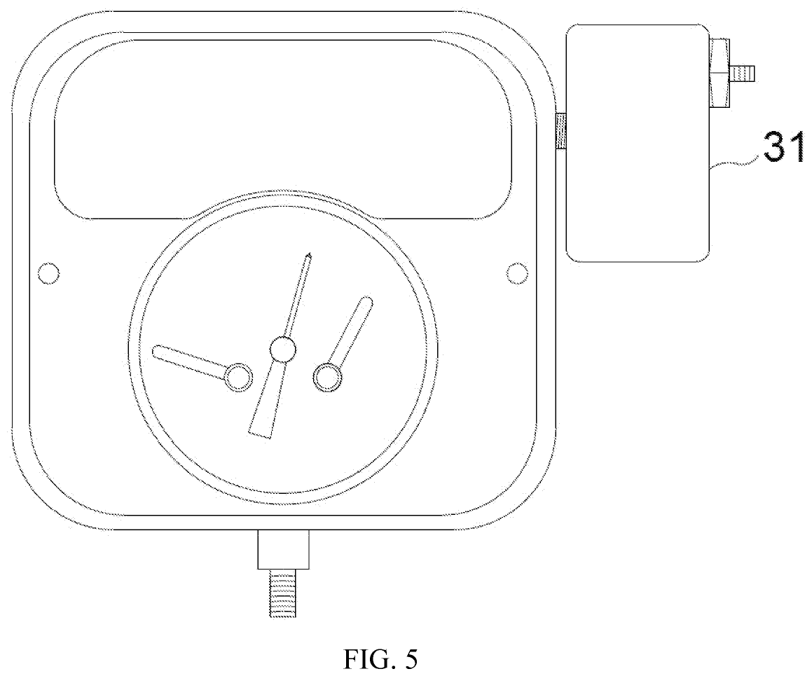

### DETAILED DESCRIPTIONS OF INVENTIONS

Reference will now be made in detail to various embodiments of the present inventions, examples of which are illustrated in the accompanying drawings and described below. While the inventions will be described in conjunction with exemplary embodiments of the present invention, it will be understood that the present description is not intended to limit the inventions to those exemplary embodiments. On the other hand, the inventions is/are intended to cover not only the exemplary embodiments of the present invention, but also various alternatives, modifications, equivalents and other embodiments, which may be included within the spirit and scope of the invention as defined by the appended claims.

Exemplary embodiments of the present application will be described more fully hereinafter with reference to the accompanying drawings, in which exemplary embodiments of the invention are shown. As those skilled in the art would realize, the described embodiments may be modified in various different ways, all without departing from the spirit or scope of the present invention.

The drawings and description are to be regarded as illustrative in nature and not restrictive, and like reference numerals designate like elements throughout the specification.

NOTE: For simplicity of illustration, resistors, transistors, capacitors, connectors, processor(s) and minutiae of common electronic industry components are not depicted as they are known to those with skill in the art. If they are shown, it is purely for illustrative purposes and not intended to capture all embodiments of the invention disclosed.

The present invention comprising: housing(9), antenna connector(8) one or more PCB(s)(5) populated with necessary circuitry, programming interface(7), one or more batteries(6), a pressure and/or temperature measuring assembly(20), process inlet(1), pressure indication needle(2), pressure value indication(s)(4) on gauge face(3), and one or more adjustable switch contacts(12)(13) which are adjustable without tooling or software.

Desired operational parameters are set with one or more adjustable switch contacts(12)(13) pointed at the desired pressure indication value(s)(4) wherein the present invention(10) is desired to operate. When the indication needle(2) makes physical contact with adjustable switch contact(s)(12)(13), a circuit is completed between an input(15)(16) on the PCB(5) and a ground on the PCB(5). This completed circuit is recognized by the processor(s)(17) on the PCB(5).

During normal operation, PCB(5) circuitry operates in periodic standby and awake modes. During standby mode, PCB(5) circuitry operates in a low-power, unresponsive state. Upon entering awake mode, PCB(5) circuitry scans the state of input(s)(15)(16) on the PCB(5) which are electrically coupled to adjustable switch contact(s)(12)(13). PCB(5) circuitry then scans the battery(6) voltage value(s). The state of the input(s)(15)(16) on the PCB(5) and/or the battery(6) voltage value(s) are then transmitted from a wireless transmitter module(18) electrically coupled to PCB(s)(5). PCB(s) (5) circuitry then renters standby mode again, cyclically repeating described operation. Typical standby time duration is 7 seconds; typical wake time duration is 60 milliseconds.

The wireless portion of the present invention(10) may require various password and/or network configurations. Configuration(s) are initiated and completed via PCB's(5) programming interface(s) (7)(19). Programming interface(7)(19) can either be a physical, wired connection interface(7), and/or and wireless connection interface(19). Device is capable of being powered solely via programming cable. However, if PCB(5) is operating using battery power when power is applied via programming cable, a power switching circuit disconnects battery power and switches to power delivered via configuration cable.

Another embodiment of the present invention(10) can house the PCB(s)(5) and antenna connector(8) in a separate housing(31) attached in some way to the pressure and/or temperature measuring assembly(20) housing(9).

The foregoing descriptions of specific exemplary embodiments of the present inventions have been presented for purposes of illustration and description. They are not intended to limit the invention to the precise construction and compositions disclosed herein. Those skilled in the art will realize various substitutions, additions, deletions, and/or modifications from the embodied description without departing from the spirit and scope of the invention as defined in the appended claims.

I claim:

1. A pressure and/or temperature measuring apparatus comprising:
pressure and/or temperature measuring assembly, wherein said assembly utilizes adjustable switch contact(s);
one or more PCB(s) populated with necessary circuitry;
one or more batteries.

2. The pressure and/or temperature measuring apparatus of claim 1, wherein: pressure and/or temperature measuring assembly comprising:
an inlet coupled to measuring assembly;
a pointer indicator which is actuated in some way via pressure/temperature measuring assembly;
a gauge face which aids indication of measured values;
one or more adjustable switch contact(s).

3. The pressure and/or temperature measuring apparatus of claim 1 wherein: PCB(s) circuity comprising:
a wireless transmitter module which transmits information derived from the pressure and/or temperature measuring assembly and/or any information within PCB components and/or circuitry;
a wireless transmitter module and/or physical connection port for device configuration;
a power switching circuit which switches power source from battery to power delivered via configuration cable once a physical connection is made;
micro-processor(s) operable to:
determine if pressure and/or temperature measuring assemblies' switch contacts are closed or open,
determine battery voltage value,
enter a power conservation mode,
exit power conservation mode and transmit information.

4. The PCB(s) of claim 2, wherein a wireless transmitter's wireless data comprising:
electrical state of pressure and/or temperature measuring apparatus' switch contacts;
battery(s) voltage value.

5. The pressure and/or temperature measuring assembly of claim 2, wherein pressure and/or temperature measuring assembly is contained within housing.

6. The wireless data of claim 4, wherein a wireless data is strongly encrypted.

7. The pressure and/or temperature measuring assembly of claim 3, wherein PCB(s) may be located within pressure and/or temperature measuring apparatus housing, or may be located within any housing attached to the pressure and/or temperature measuring apparatus housing.
